(19) United States
(12) Patent Application Publication
(10) Pub. No.: US 2007/0064808 A1
(43) Pub. Date: Mar. 22, 2007

(54) Coding device and coding method enable high-speed moving image coding

(75) Inventors: Yasuo Ishii, Anpachi-gun (JP); Mitsuru Suzuki, Anpachi-gun (JP); Shigeyuki Okada, Ogaki-shi (JP)

Correspondence Address: MCDERMOTT WILL & EMERY LLP, 600 13TH STREET, N.W., WASHINGTON, DC, 20005-3096, US

(73) Assignee: SANYO ELECTRIC CO., LTD.

(21) Appl. No.: 11/520,709

(22) Filed: Sep. 14, 2006

(30) Foreign Application Priority Data
Sep. 22, 2005 (JP) 2005-276417

(51) Int. Cl. H04N 11/02; H04N 11/04

(52) U.S. Cl. 375/240.16; 375/240.24

(57) ABSTRACT

With the motion vector detection for the macro blocks according to the entire macro block search method, the processing is consecutively performed for a set of adjacent upper and lower macro blocks as a target macro block group. Of the reference image data held by frame memory, pixel data of a composite search region, which is the sum of two motion vector search regions corresponding to each macro blocks included in the target macro block group, is transmitted in batch to fast memory. Then, before the processing for the next target macro block group, only the pixel data of the region, which is newly selected as a part of the composite search region, is transmitted to the fast memory.

### BACKGROUND OF THE INVENTION

1. Field of the Invention

The present invention relates to a coding device and a coding method for coding a moving image.

2. Description of the Related Art

The rapid development of the broadband network has increased consumer expectations for the service that provide high-quality moving images. On the other hand, large capacity storage media such as DVD and so forth are used for storing high-quality moving images. This increases the segment of the users who enjoy high-quality images. A compression coding method is an indispensable technique for transmission of moving images via a communication line, and storing the moving images in a storage medium. Examples of international standards of moving image compression coding techniques include the MPEG-4 standard, and the H.264/AVC standard. Furthermore, SVC (Scalable Video Coding) is known, which is a next-generation image compression technique that includes both high image quality stream and low image quality stream functions.

With compression coding and decoding of moving images, the moving images are stored in frame memory in increments of frames, and motion compensation is performed with reference to the frame memory. This requires high frequency data transmission from the frame memory. In particular, creation of higher quality moving images requires motion detection in increments of blocks each of which is formed of a small number of image pixels. This increases the data amount used for the motion compensation. Accordingly, the demand for memory bandwidth can easily lead to a bottleneck in the processing. The Japanese Patent Application Laid-open No. 11-298903 discloses a digital image decoding device having a function of improving the bandwidth usage efficiency of frame memory.

At the time of compression coding of moving images, motion vector detection is performed for the target macro block of a coding target frame. With the motion vector detection, the macro block matching the target macro block is detected within the pixel region corresponding to a predetermined search region in a reference frame while reading out the pixel region from the frame memory. With such motion vector detection, the macro block matching the target macro block is detected within the reference frame by repeated detection. This requires a great number of readouts from the frame memory, increasing the data transmission amount. Such data transmission takes up most of the transmission bandwidth of the frame memory. As a result, access to the frame memory becomes bottlenecked, leading to a problem of reduced processing speed for the compression coding.

3. Related Art List

Japanese Patent Application Laid-open No. 11-298903

### SUMMARY OF THE INVENTION

The present invention has been made in view of the aforementioned problems. Accordingly, a general purpose thereof invention is to provide a coding technique for coding a moving image with improved coding processing efficiency by reducing access to frame memory.

An embodiment according to the present invention relates to a coding device. The aforementioned coding device is a device for coding pictures of a moving image, and comprises: frame memory which holds a reference picture used as a reference for performing motion detection for a coding target picture; a motion detection unit which repeatedly performs motion detection for each block with a predetermined block width defined in the coding target picture with reference to the reference picture held by the frame memory. Furthermore, the motion detection unit includes internal memory for reading out the pixel data of a composite search region from the frame memory, with the composite search region including the sum of motion search regions defined in the reference picture corresponding to multiple blocks included in a target block group formed of a plurality of adjacent blocks positioned along a predetermined direction. With such an arrangement, the motion detection unit alternately performs: a first step in which motion detection is consecutively performed for multiple blocks included in the target block group by searching the motion search region included in the composite search region held by the internal memory; and a second step in which the consecutive motion detection is repeatedly performed for a plurality of blocks included in the next target block group adjacent to the previous target block group in a direction different from the predetermined direction, thereby executing motion detection for the coding target picture.

The term “the sum of the motion search regions” as used here represents a region including all the motion search regions respectively corresponding to each blocks included in a target block group. The term “a plurality of adjacent blocks positioned along a predetermined direction” as used here represents blocks positioned adjacent to one another along the horizontal direction, the vertical direction, or an oblique direction in a picture. The predetermined direction is not restricted in particular. In a case of employing multiple blocks positioned adjacent to one another along an oblique direction as a target block group, the term “the next target block group adjacent to the previous target block group in a direction different from the predetermined direction” represents the target block group adjacent in the horizontal direction or vertical direction in the picture.

The term “picture” as used here represents a coding unit. Examples of the coding units include a frame, a field, a VOP (Video Object Plane), etc.

With such an embodiment, the pixel data of the motion search regions for multiple adjacent blocks is stored simultaneously in the internal memory. Such an arrangement allows the same data to be used for the overlapping region of the motion search region for the multiple blocks, thereby reducing the data transmission amount from the frame memory.

Another embodiment according to the present invention relates to a coding method. The aforementioned coding method is a method for performing motion detection for each block having a predetermined block width defined in a picture of a moving image, and outputting coded data. The aforementioned coding method comprises: performing consecutive motion detection for multiple adjacent blocks included in a target block group formed of the plurality of adjacent blocks positioned along a predetermined direction; advancing motion detection by repeatedly performing the consecutive motion detection for a plurality blocks included in the next target block group adjacent to the previous target block group in a direction different from the predetermined direction; and outputting corresponding coded data according to a sequence of motion detection performed for the blocks.

Arbitrary combinations of the aforementioned constituting elements, and implementation of the invention in the form of methods, devices, systems, computer programs, recording mediums, and so forth, may also be practiced as additional modes of the present invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a diagram which shows the configuration of a coding device according to a first embodiment;

FIG. 2 is a diagram which shows the configuration of a motion compensation unit shown in FIG. 1;

FIG. 3 is a schematic diagram which shows the processing procedure in a step where a motion vector is detected according to a generally-used entire macro block search method;

FIG. 4 is a schematic diagram which shows the shift in the search regions for two target macro blocks consecutively processed according to the processing sequence shown in FIG. 3;

FIG. 5 is a schematic diagram which shows the processing procedure in the step where a motion vector is detected for each macro block according to the first embodiment;

FIG. 6 is a schematic diagram which shows the shift in the search regions for four target macro blocks consecutively processed according to the processing sequence shown in FIG. 5;

FIG. 7 is a diagram for describing the positional relation among the macro blocks necessary for the differential coding of a motion vector according to the H.264/AVC;

FIG. 8 is a schematic diagram which shows the processing procedure in the step where a motion vector is detected for each macro block according to the second embodiment; and

FIG. 9 is a schematic diagram which shows the shift in the search regions for four target macro blocks consecutively processed according to the processing sequence shown in FIG. 8.

### DETAILED DESCRIPTION OF THE INVENTION

### First Embodiment

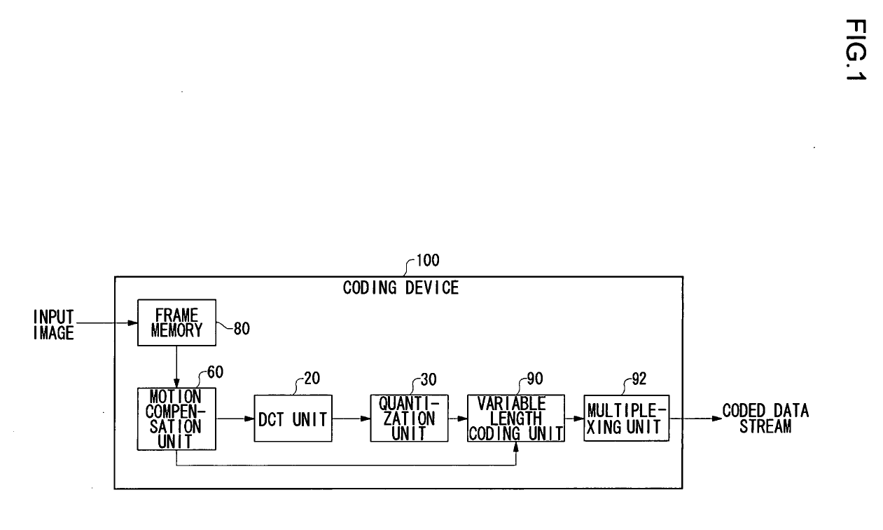

FIG. 1 is a configuration diagram which shows a coding device 100 according to an embodiment. This configuration can be realized by hardware means, e.g., by actions of a CPU, memory, and other LSIs, of a computer, or by software means, e.g., by actions of a program having a function of image coding or the like, loaded into the memory. Here, the drawing shows a functional block configuration which is realized by cooperation between the hardware components and software components. It is needless to say that such a functional block configuration can be realized by hardware components alone, software components alone, or various combinations thereof, which can be readily conceived by those skilled in this art.

The coding device 100 according to the present embodiment performs coding of moving images according to the MPEG (Moving Picture Experts Group) series standards (MPEG-1, MPEG-2, and MPEG-4) standardized by the international organization for standardization, ISO (International Organization for Standardization)/IEC(International Electrotechnical Commission), the H.26x series standards (H.261, H.262, and H.263) standardized by the international organization for standardization with respect to electric communication ITU-T (International Telecommunication Union-Telecommunication Standardization Sector), or the H.264/AVC standard which is the newest moving image compression coding standard jointly standardized by both the aforementioned standardization organizations (these organizations have advised that this H.264/AVC standard should be referred to as “MPEG-4 Part 10: Advanced Video Coding” and “H.264”, respectively).

With the MPEG series standard, in a case of coding an image frame in the intra-frame coding mode, the image frame to be coded is referred to as “I (Intra) frame”. In a case of coding an image frame with a prior frame as a reference image, i.e., in the forward interframe prediction coding mode, the image frame to be coded is referred to as “P (Predictive) frame”. In a case of coding an image frame with a prior frame and an upcoming frame as reference images, i.e., in the bi-directional interframe prediction coding mode, the image frame to be coded is referred to as “B frame”.

On the other hand, with the H.264/AVC standard, image coding is performed using a reference image regardless of the time at which the reference image has been acquired. For example, image coding may be made with two prior image frames as reference images. Also, image coding may be made with two upcoming image frames as reference images. Furthermore, the number of the image frames used as the reference images is not restricted in particular. For example, image coding may be made with three or more image frames as the reference images. Note that, with the MPEG-1/2/4 standard, the term “B frame” represents the bi-directional prediction frame. On the other hand, with the H.264/AVC standard, the time at which the reference image is acquired is not restricted in particular. Accordingly, the term “B frame” represents the bi-predictive prediction frame.

Note that description will be made in the present embodiment regarding an arrangement in which coding is performed in increments of frames. Also, coding may be performed in increments of fields. Also, coding may be performed in increments of VOPs stipulated in the MPEG-4.

The coding device 100 receives the input moving images in increments of frames, performs coding of the moving images, and outputs a coded stream. The moving image frames thus input are stored in frame memory 80.

A motion compensation unit 60 performs motion compensation for each macro block of a P frame or B frame with a prior or upcoming image frame stored in the frame memory 80 as a reference image, thereby creating the motion vector and the predicted image. The motion compensation unit 60 makes a subtraction between the image of the P frame or B frame to be coded and the prediction image, and supplies the subtraction image to a DCT unit 20. Furthermore, the motion compensation unit 60 supplies the motion vector thus created to a variable-length coding unit 90.

The DCT unit 20 performs discrete cosine transform (DCT) processing for the image supplied from the motion compensation unit 60, and supplies the DCT coefficients thus obtained, to a quantization unit 30.

The quantization unit 30 performs quantization of the DCT coefficients and supplies the quantized DCT coefficients to the variable-length coding unit 90. The variable-length coding unit 90 performs variable-length coding processing for the quantized DCT coefficients created based upon the subtraction image, and the motion vector supplied from the motion compensation unit 60, and supplies the coded data sets to a multiplexing unit 92. The multiplexing unit 92 multiplexes the coded DCT coefficients and the coded motion vector information supplied from the variable-length coding unit 90, thereby creating a coded stream. In the step of creation of the coded stream, the multiplexing unit 92 sorts the coded frames in order of time.

Description has been made regarding coding processing for a P frame or B frame, in which the motion compensation unit 60 operates as described above. On the other hand, in a case of coding processing for an I frame, the I frame subjected to intra-frame prediction is supplied to the DCT unit 20 without involving the motion compensation unit 60. Note that this coding processing is not shown in the drawings.

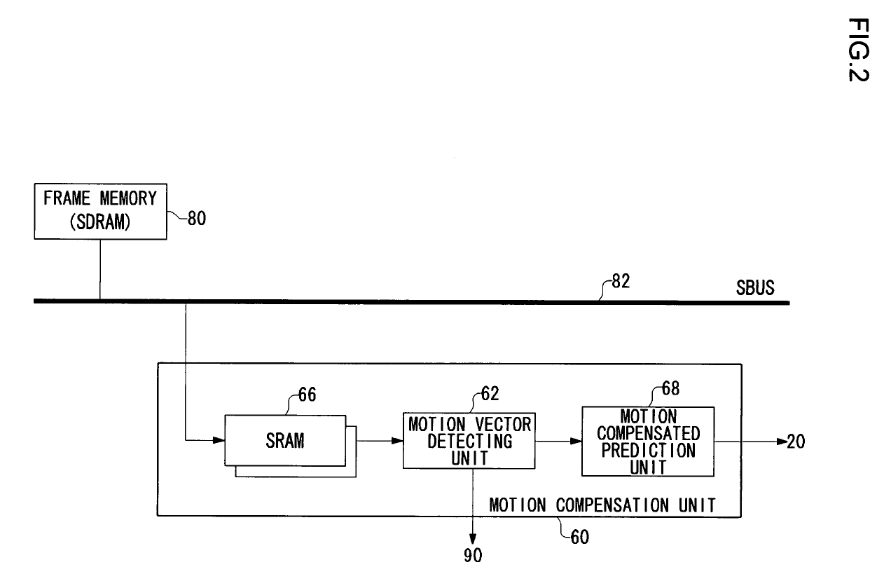

FIG. 2 is a diagram for describing a configuration of the motion compensation unit 60 in the present embodiment. With such a configuration, the frame memory 80 and the motion compensation unit 60 are connected with each other via a SBUS 82. The motion compensation unit 60 makes a request to the frame memory 80 for the data by specifying the data address. Then, the motion compensation unit 60 receives the data transmitted from the frame memory 80 via the SBUS 82.

The motion compensation unit 60 includes SRAM 66, a motion vector detection unit 62, and a motion compensation prediction unit 68. The motion vector detection unit 62 transmits the pixel data of the reference image search region held by the frame memory 80 to the SRAM 66.

The frame memory 80 is made up of large-capacity SDRAM, and can be accessed via the SBUS 82, for example. On the other hand, the SRAM 66 is formed within the same integrated circuit in which the motion vector detection unit 62 is formed. Such an arrangement enables high-speed access to the SRAM 66 from the motion vector detection unit 62. The SRAM 66 has a limited storage capacity as compared with the frame memory 80; the SRAM 66 serves as high-speed cache memory for the frame memory 80. The SRAM 66 exhibits high-speed data transmission performance. With the present embodiment, the SRAM 66 is suitably employed as follows. That is to say, the motion vector detection unit 62 performs motion detection while making reference to the pixel region stored in the SRAM 66. Note that, in general, the SRAM 66 is made up of multiple SRAM units 66, thereby increasing the readout ports.

The motion vector detection unit 62 performs motion vector detection while making reference to the pixel data transmitted to the SRAM 66. The motion vector detection unit 62 searches the reference image for the predicted macro block which exhibits the smallest deviation from the target macro block, and calculates the motion vector which represents the motion from the target macro block to the predicted macro block. The motion detection is performed by searching the reference image for the reference macro block matching the target macro block while shifting the reference macro block in integer or decimal increment of pixels. In general, the search processing is repeatedly performed in the pixel region multiple times. Then, the reference macro block that most closely matches the target macro block is selected as the predicted macro block based upon the multiple search results. The motion vector thus obtained is supplied to the motion compensation prediction unit 68 and the variable-length coding unit 90.

The motion compensation prediction unit 68 performs motion compensation processing for the target macro block using the motion vector, thereby creating the predicted image. Then, the motion compensation prediction unit 68 makes the subtraction image between the coding target image and the predicted image, and outputs the subtraction image to the DCT unit 20.

Let us consider a motion vector detection method such as a tracking method and gradient method, in which search processing is repeatedly performed during calculation of the search direction. In this case, the pixel data used for each instance of search processing is transmitted to the SRAM 66 from the frame memory 80. Let us consider motion vector detection in which the 16×16 pixels predicted macro block which most closely matches the target macro block is detected based upon search results from six search instances. Furthermore, let us say that searching is performed using a 6-tap filter with ¼ pixel precision. In this case, image data with a width of 21 pixels and a height of 21 pixels, including the pixels around the macro block, is transmitted to the SRAM 66 for each search processing. This transmission is repeated six times. Accordingly, motion vector detection requires a data transmission amount of 21×21×6 pixels, i.e., 2646 bytes, for each target macro block. Note that description has been (and will be) made with the information amount of each pixel as 1 byte, for convenience of explanation.

The tracking method or the gradient method with improved search precision requires an increased number of search cycles. This leads to an increased data transmission amount in proportion to the number of the search cycles. As a result, data transmission from the frame memory 80 to the SRAM 66 becomes bottlenecked, leading to a problem of reduced processing performance. In order to solve the aforementioned problem, an arrangement can be conceived in which multiple frame memory sets 80 are provided, and data transmission is performed via multiple SBUs 82 provided to respective frame memory sets 80, for example. However, -such an arrangement leads to increased manufacturing costs.

Also, another motion vector detection method, i.e., the entire macro block search method is known, in which matching processing is performed between the target macro block and each one of all the macro blocks set in a predetermined search region, and the macro block that most closely matches the target macro block is selected as the predicted macro block. With the entire macro block search method, all the pixel data of a predetermined search region is transmitted from the frame memory 80 to the SRAM 66. In this case, the motion vector detection unit 62 searches the pixel region transmitted to the SRAM 66 for-the motion vector. The entire macro block search method requires only one-time data transmission. Let us consider an arrangement in which the motion vector is detected for the target macro block with a width of 16 pixels and height of 16 pixels with reference to a search region including the target macro block region and 32 pixels around, i.e., with a size of 80×80 pixels. With such an arrangement, motion vector detection requires a data transmission amount of 80×80 pixels, i.e., 6400 bytes, for each target macro block.

With regard to the entire macro block search method, let us consider a case in which there is an overlapping region between a search region for a given target macro bock and another search region for the next target macro block. In this case, the pixel data of the overlapping region may be continuously stored in the SRAM 66. With such an arrangement, only the pixel data of the region, which has been newly selected as the search region, is transmitted from the frame memory 80 to the SRAM 66, whereby the SRAM 66 holds the pixel data of the search region for the next target block.

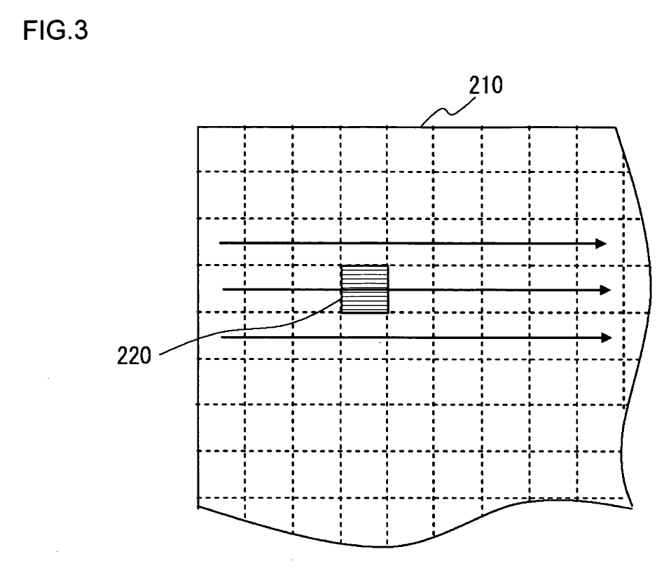

In order to provide a clear understanding of the features of the present embodiment, description will be made regarding the procedure of the generally-used entire macro block search method. FIG. 3 is a schematic diagram which shows the processing procedure in the step where a motion vector is detected for each macro block. As shown in the drawing, each of the macro blocks obtained by dividing a frame 210 in increments of predetermined pixel units is selected as a target macro block 220, and motion vector detection is performed for the target macro block 220. In this step, as indicated by the arrow in the drawing, each macro block is selected from a row of pixels from the left to the right. The order of the macro blocks thus selected is the same as the sequence of the macro blocks that form a coded stream output from the coding device.

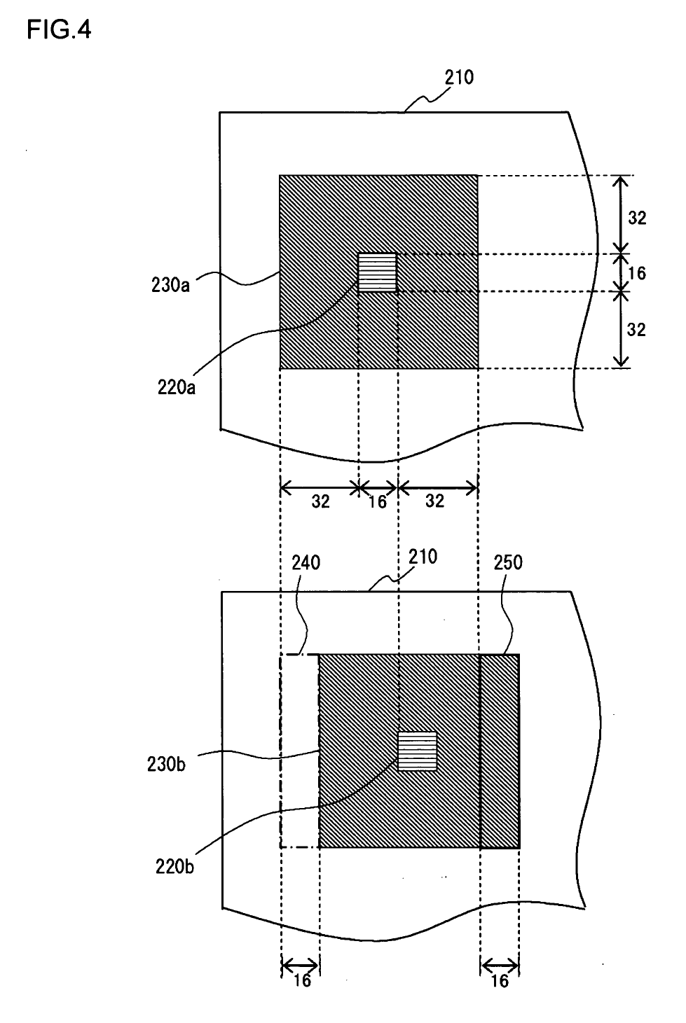

FIG. 4 is a schematic diagram which shows the shift in the search region for two target macro blocks consecutively processed according to the aforementioned generally-used entire macro block search method. That is to say, upon completion detection of the motion vector for the target macro block 220a, motion vector detection is started for the target macro block 220b. In the aforementioned example shown in FIG. 4, the search region 230a for the target macro block 220a is an 80×80 pixel region including 32 pixels around the macro block 220a. In this stage, the SRAM 66 holds the image data of the search region 230a. Upon completion of motion vector detection for the target macro block 220a, the search region for the target macro block is set to the search region 230b for the next target macro block 220b shown in FIG. 4. In this stage, of the pixel data of the search region 230a held by the SRAM 66, the data of the region 240, which is not included in the current search region 230b, is discarded. On the other hand, the data of the region 250, which is newly selected as a part of the search region 230b, is transmitted from the frame memory 80 to the SRAM 66. In the example shown in the drawing, detection of the motion vector for a target macro block requires transmission of data of 80×16=1280 bytes.

As described above, the entire macro block search method has the advantage of a reduced data transmission amount as compared with the tracking method and the gradient method. On the other hand, in recent years, a full high-vision image of 1920×1088 pixels is becoming widespread for general use. Let us consider a case in which motion vector detection is performed for such an image in the same way as described above. In this case, 8160 macro blocks of 16×16 pixels as described above are defined in the entire image. Furthermore, let us say that processing at 30 fps, i.e., real-time processing, is performed for all the macro blocks with two frames as reference images. Such processing requires an extremely high transmission rate of 1280×8160×2×30=598 Mbytes/second.

As the image definition is higher, so the bandwidth of the SBUS 82 taken up by data transmission is greater. This easily leads to a bottleneck in the coding processing. From the perspective of such a bottleneck problem, the present inventors have understood that there is a demand for improved data transmission from the frame memory 80. Description will be made below regarding a processing procedure for motion vector detection according to the present embodiment.

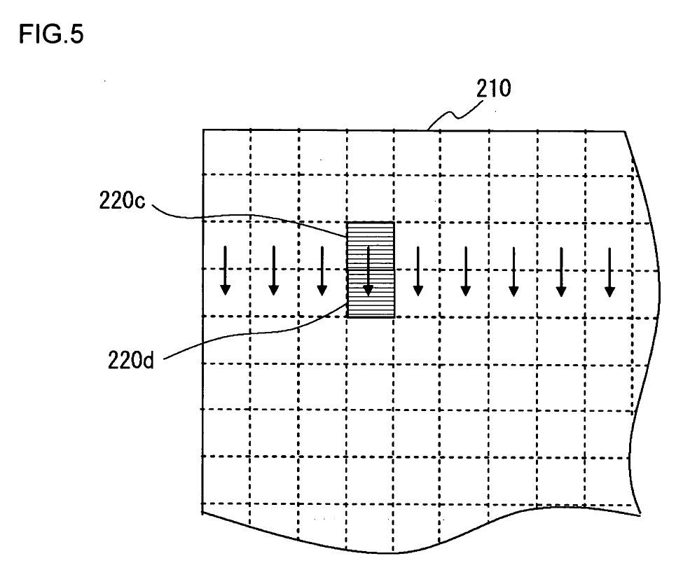

FIG. 5 is a schematic diagram which shows the processing procedure in the step where a motion vector is detected for each macro block by the motion vector detection unit 62 according to the present embodiment. With the present embodiment, the adjacent upper and lower macro blocks are consecutively subjected to the processing as indicated by the arrow. That is to say, upon completion of motion vector detection for the target macro block 220c, in the next step, motion vector detection is performed for the target macro block 220d at a lower position. Upon completion of the processing for a pair of the upper and lower macro blocks, in the next step, the processing is performed for a new pair of upper and lower macro blocks positioned on the right side thereof. That is to say, the processing for a pair of upper and lower macro blocks is performed along the horizontal direction from the left to the right.

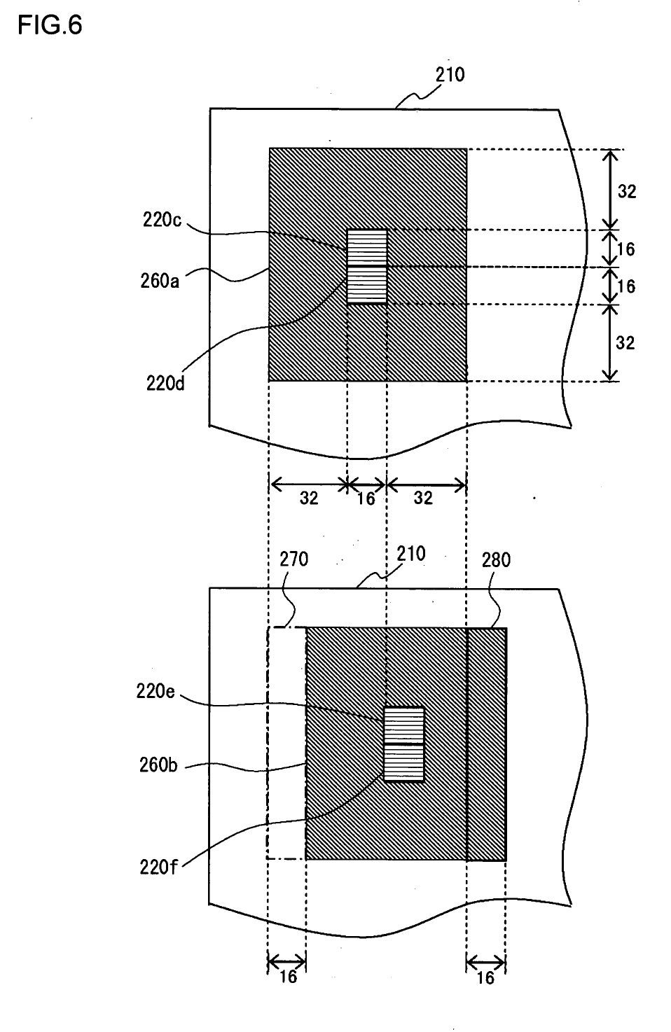

FIG. 6 is a schematic diagram which shows the shift in the search region in a case of motion vector detection according to the procedure shown in FIG. 5. With the present embodiment, a pair of upper and lower macro blocks is handled as a unit for motion vector detection. That is to say, the pixel data of the composite search region, which is formed of two search regions corresponding to the upper and lower macro blocks, is transmitted to the SRAM 66 as a single batch. That is to say, as shown in FIG. 6, the pixel data of the composite search region 260a, which is the sum of the search regions for the target macro block 220c and the target macro block 220d, is transmitted when starting the processing for the target macro block 220c. In the aforementioned example, the composite search region 260a is a region with a height of 96 pixels and a width of 80 pixels, as shown in the drawing. The motion vector detection unit 62 performs motion vector detection for the target macro blocks 220c and 220d using the pixel data for each search region included in the pixel data of the composite search region 260a held by the SRAM 66.

Upon completion of motion vector detection for the target macro blocks 220c and 220d, in the next step, a new pair of the target macro blocks is set to the adjacent pair of the macro blocks 220e and 220f on the right side thereof. In this case, a new composite search region is set to the composite search region 260b corresponding to the target macro block 220e and 220f shown in FIG. 6. With such an arrangement, of the pixel data of the composite search region 260a held by the SRAM 66, the data of the region 270, which is not included in the current composite search region 260b, is discarded. On the other hand, the pixel data of the region 280, which is newly selected as a part of the composite search region 260b, is transmitted from the frame memory 80 to the SRAM 66. In the example shown in the drawing, motion vector detection for each pair of the target macro blocks requires transmission of data of 96×16=1536 bytes. That is to say, motion vector detection for each target macro block requires transmission of data of 768 bytes. As a result, with the present embodiment, the data transmission amount is reduced to 60% of that with the procedure according to the generally-used entire macro block search method shown in FIG. 4.

As described above, with the present embodiment, the target macro blocks are consecutively subjected to the processing using an overlapping region extending along the vertical direction, in addition to an overlapping region extending along the horizontal direction. Such an arrangement reduces the data transmission amount from the frame memory 80 to the SRAM 66, thereby providing coding processing suitable for a high definition image. Furthermore, the present embodiment provides coding processing without the need to increase the number of memory sets or the need to extend the bus bandwidth, thereby suppressing introduction costs.

An arrangement may be made in which the motion vector detection unit 62 sorts the motion vectors consecutively obtained by processing for the target macro blocks 220 according to the aforementioned procedure, before transmitting them to the variable-length coding unit 90. That is to say, an arrangement may be made in which the motion vectors of macro blocks necessary for differential coding for a target macro block is transmitted to the variable-length coding unit 90 before transmission of the motion vector of the target macro block.

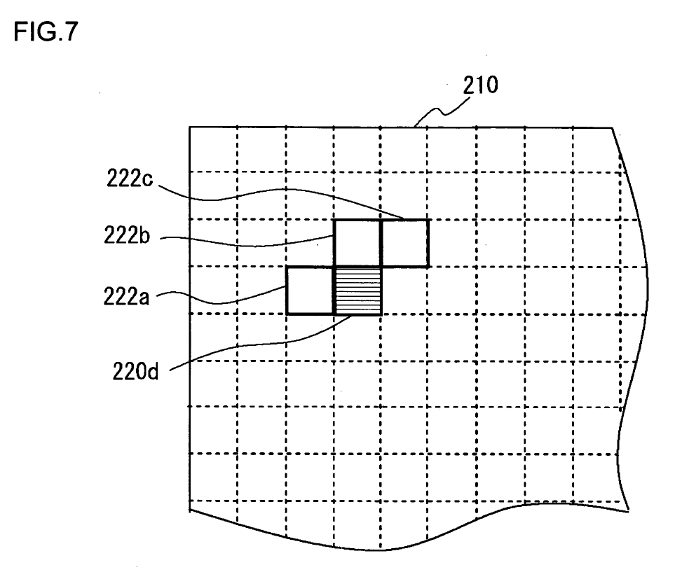

FIG. 7 is a diagram for describing the positional relation among the macro blocks necessary for the differential coding of a motion vector according to the H.264/AVC. Let us consider a case in which differential coding is performed for the motion vector of a target macro block 220d according to the H.264/AVC. In this case, three motion vectors of the macro blocks 222a, 222b, and 222c, are used for calculation. With the present embodiment, the motion vector of the macro block 222c has not yet obtained at the point that the motion vector detection unit 62 has obtained the motion vector of the target macro block 220d. Accordingly, with the present embodiment, the motion vector of the target macro block 220d is stored in an unshown buffer or the like. Upon acquisition of the motion vector of the macro block 222c, this macro block is transmitted to the variable-length coding unit 90 before transmission of the motion vector of the target macro block 222d. Subsequently, the motion vector of the target macro block 222d is supplied from the aforementioned buffer to the variable-length coding unit 90. Thus, the present embodiment can be applied to such an arrangement without the need to modify the procedure of the processing performed by the variable-length coding unit 90.

### Second Embodiment

The coding device 100 and the motion compensation unit 60 have the same configurations as those of the first embodiment as described above with reference to FIGS. 1 and 2. The difference therebetween is as follows. That is to say, with the present embodiment, the motion vector detection unit 62 consecutively performs the processing for two target macro blocks positioned along an oblique direction. Now, description will be made mainly regarding the difference therebetween.

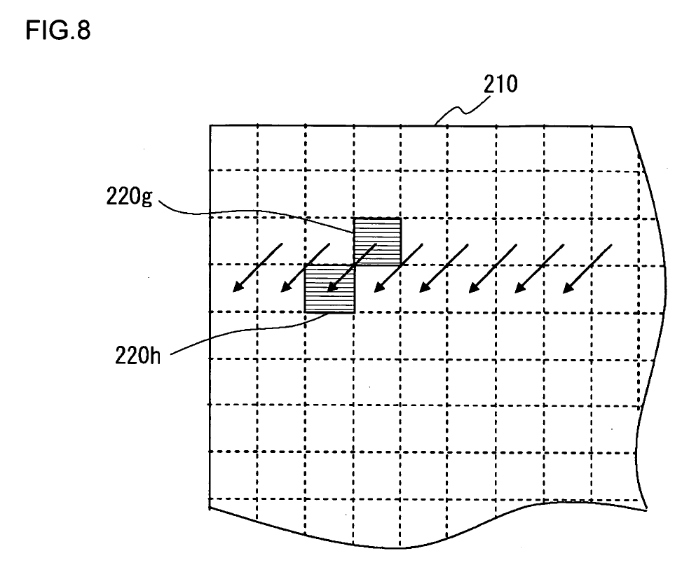

FIG. 8 is a schematic diagram which shows the processing procedure in the step where a motion vector is detected for each macro block by the motion vector detection unit 62 according to the present embodiment. With the present embodiment, processing is consecutively performed for a pair of adjacent macro blocks, made up of an upper-right macro block and a lower-left macro block as indicated by the arrows in the drawing. Specifically, upon completion of motion vector detection for the target macro block 220g, in the next step, motion vector detection is performed for the lower-left target macro block, i.e., the target macro block 220h. Upon completion of the processing for a pair of upper-right and lower-left macro blocks, in the next step, the processing is performed for a new pair of upper-right and lower-left macro blocks positioned on the right side thereof. That is to say, the processing for a pair of upper-right and lower-left macro blocks is performed along the horizontal direction from the left to the right.

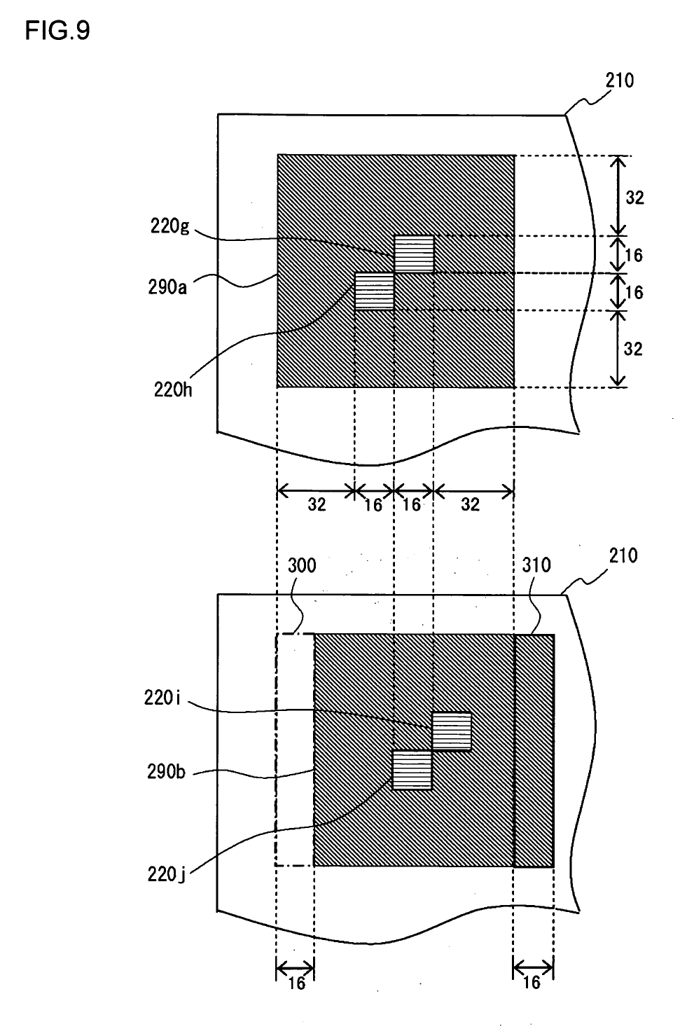

FIG. 9 is a schematic diagram which shows the shift in the search regions in case of motion vector detection according to the procedure shown in FIG. 8. With the present embodiment, the pixel data of the composite search region formed of two search regions corresponding to a pair of macro blocks is transmitted to the SRAM 66 in batch in the same way as with the first embodiment. The difference therebetween is that, with the present embodiment, the two adjacent macro blocks, which form a pair, are positioned obliquely as described above. Accordingly, the composite search region 290a for such a pair is a region as shown in FIG. 9. That is to say, the smallest rectangular region, which includes the search regions for the target macro block 220g and the target macro block 220h, is employed as the composite search region 290a. Specific description will be made below in the same way as in the first embodiment. The composite search region 290a is a 96×96 pixel region as shown in the drawing. The motion vector detection unit 62 performs motion vector detection for the target macro blocks 220g and 220h using the pixel data of the respective search regions included in the pixel data of the composite search region 290a held by the SRAM 66.

Upon completion of motion vector detection for the target macro blocks 220g and 220h, in the next step, a new pair of the target macro blocks is set to the adjacent pair of the macro blocks 220i and 220j on the right side thereof. In this case, a new composite search region is set to the composite search region 290b corresponding to the target macro block 220i and 220j shown in FIG. 9. With such an arrangement, of the pixel data of the composite search region 290a held by the SRAM 66, the pixel data of the region 300 which is not included in the current composite search region 290b, is discarded in the same way as with the first embodiment. On the other hand, the pixel data of the region 310, which is newly selected as a part of the composite search region 290b, is transmitted from the frame memory 80 to the SRAM 66. In the example, motion vector detection for each pair of the target macro blocks 220 requires transmission of data of 96×16=1536 bytes in the same way as with the first embodiment. That is to say, motion vector detection for each target macro block requires transmission of data of 768 bytes.

With the present embodiment, the target macro blocks are consecutively subjected to the processing using an overlapping region extending along the vertical direction, in addition to an overlapping region extending along the horizontal direction in the same way as with the first embodiment. Such an arrangement reduces the data transmission amount from the frame memory 80 to the SRAM 66, thereby providing coding processing suitable for a high definition image. Furthermore, the present embodiment also provides coding processing without the need to increase the number of memory sets or the need to extend the bus bandwidth, thereby suppressing introduction costs.

Furthermore, the present embodiment provides the advantage of enabling differential coding of a motion vector to be performed according to H.264/AVC without the need to sort the motion vectors necessary for the first embodiment described above. Specifically, in the example shown in FIG. 7, before acquisition of the motion vector of the target macro block 220d, the motion vectors of the macro blocks 222a, 222b, and 222c, have been obtained. This allows the variable-length coding unit 90 to perform differential coding of the motion vectors according to the order of acquisition without any difficulty. Thus, the present embodiment can be applied to such an arrangement without the need to provide any sorting mechanism to the motion compensation unit 60.

Description has been made regarding the present invention with reference to the embodiments. The above-described embodiments have been described for exemplary purposes only, and are by no means intended to be interpreted restrictively. Rather, it can be readily conceived by those skilled in this art that various modifications may be made by making various combinations of the aforementioned components, which are also encompassed in the technical scope of the present invention.

Description has been made in the first embodiment regarding an arrangement in which a pair of adjacent macro blocks, made up of an upper macro block and a lower macro block is employed as a unit of detection, and pixel data of the search regions corresponding to the pair of macro blocks are transmitted to SRAM in batch. A modification may be made in which a set of three or more adjacent macro blocks positioned along the vertical direction, e.g., a set of the upper, middle, and lower macro blocks, is employed as a unit of detection. With such an arrangement, in a case of increasing a macro bock included in the unit of detection, the composite search region is extended in the vertical direction according to the pixels of the additional macro block along the vertical direction. Therefore, the additional macro block in the unit of detection leads the increase of the amount of data held in SRAM. However, this increases the overlapping region available for motion vector detection for these macro blocks, thereby further reducing the data transmission amount. Accordingly, the optimum number of the macro blocks which form each unit of detection should be determined giving consideration to the capacity of the SRAM, required data transmission time, required data transmission amount, etc. This provides higher-efficiency motion vector detection.

Also, as a modification similar to the aforementioned modification, a modification may be made in which a set of three or more adjacent macro blocks positioned along an oblique direction is employed as a unit of detection, and the processing is performed in the same way as described in the second embodiment. With such a modification, the composite search region is extended in the horizontal direction and the vertical direction according to the number of the macro blocks included in the unit of detection. With regard to such a modification, the number of the macro blocks which form the unit of detection should also be determined giving consideration to the capacity of the SRAM and so forth, thereby providing higher-efficiency motion vector detection.

Description has been made in the first embodiment regarding an arrangement in which a pair of adjacent macro blocks, made up of an upper macro block and a lower macro block is employed as a unit of detection. Also, an arrangement may be made in which a pair of adjacent macro blocks, made up of a left macro block and a right macro block is employed as a unit of detection, and pixel data of the search regions corresponding to the pair of macro blocks are transmitted to the SRAM in batch. With such an arrangement, upon completion of the processing for a pair of left and right macro blocks, in the next step, the processing is performed for a new pair of left and right macro blocks positioned on the lower side thereof. That is to say, the processing for a pair of left and right macro blocks is performed along the vertical direction. Such an arrangement provides high-efficiency motion vector detection in the same way as described in the first Embodiment.

With regard to such arrangements described above, the sequence of the coded stream, which is to be output from the coding device, may be determined according to the motion vector detection sequence as described above. Specifically, the motion vectors obtained by the motion vector detection unit 62 are supplied to the motion compensation prediction unit 68 and the variable-length coding unit 90, in order of obtaining. Ultimately, the DCT coefficients and the motion vector information are output having been multiplexed according to a sequence of motion vector detection. With such an arrangement, coding may be performed using the data of the macro blocks for which the motion vectors have been detected, whereby variable-length coding or the like may be performed according to the motion vector detection sequence without any difficulty. For example, let us consider a case of the first embodiment. In this case, differential coding of a motion vector is performed using the motion vectors of the adjacent macro blocks on the upper, the upper-left, and the left. Such an arrangement provides improved coding efficiency due to the motion vector detection according to the present embodiment without the need to perform data sorting in any step, including a stream creation step. This further improves the coding processing rate.

What is claimed is:

1. A coding device for coding pictures of a moving image, comprising:
frame memory which holds a reference picture used as a reference for performing motion detection for a coding target picture;
a motion detection unit which repeatedly performs motion detection for each block with a predetermined block width defined in the coding target picture with reference to the reference picture held by the frame memory,
wherein the motion detection unit includes internal memory for reading out the pixel data of a composite search region from the frame memory, with the composite search region including the sum of motion search regions defined in the reference picture corresponding to a plurality of blocks included in a target block group formed of a plurality of adjacent blocks positioned along a predetermined direction,
and wherein the motion detection unit alternately performs motion detection for a plurality of blocks included in the target block group consecutively by searching the motion search region included in the composite search region held by the internal memory, and repeats the consecutive motion detection for a plurality of blocks included in the next target block group adjacent to the previous target block group in a direction different from the predetermined direction, thereby executing motion detection for the coding target picture.

2. A coding device according to claim 1, wherein a plurality of blocks included in the each target block group are positioned adjacent to one another along the vertical direction in the picture.

3. A coding device according to claim 2, wherein, before the start of the processing for the next target block group, of the composite search region corresponding to the next target block group, the pixel data in the region, which is not included in the region of the pixel data held by the internal memory, is read out from the frame memory, and the data thus read out is stored in the internal memory.

4. A coding device according to claim 2, further comprising a variable-length coding unit which performs differential coding of a motion vector obtained as a result of motion detection performed by the motion detection unit, using the motion vectors of other blocks,
wherein the motion detection unit transmits motion vectors to the variable-length coding unit according to a sequence modified based upon the positional relation between the target block and the other blocks for differential coding.

5. A coding device according to claim 2, which outputs coded data according to a sequence of motion detection performed for the blocks by the motion detection unit.

6. A coding device according to claim 1, wherein a plurality of blocks included in the each target block group are positioned adjacent to one another along an oblique direction in the picture.

7. A coding device according to claim 6, wherein, before the start of the processing for the next target block group, of said composite search region corresponding to the next target block group, the pixel data in the region, which is not included in the region of the pixel data held by the internal memory, is read out from the frame memory, and the data thus read out is stored in the internal memory.

8. A coding device according to claim 6, which outputs coded data according to a sequence of motion detection performed for the blocks by the motion detection unit.

9. A coding method for performing motion detection for each block having a predetermined block width defined in a picture of a moving image, and outputting coded data, comprising:
performing consecutive motion detection for a plurality blocks included in a target block group formed of the plurality of adjacent blocks positioned along a predetermined direction;
advancing motion detection by repeatedly performing the consecutive motion detection for a plurality blocks included in the next target block group adjacent to the previous target block group in a direction different from the predetermined direction; and
outputting corresponding coded data according to a sequence of motion detection performed for the blocks.

10. A coding method according to claim 9, wherein, in the performing consecutive motion detection, a plurality of blocks positioned adjacent to one another along the vertical direction in the picture is set to the target block group, and motion detection is consecutively performed in order from the uppermost block to the lowermost block,
and wherein, in the advancing motion detection, motion detection is advanced from the left block group to the right block group along the horizontal direction.

11. A coding method according to claim 9, wherein, in the performing consecutive motion detection, a plurality of blocks positioned adjacent to one another along an oblique direction in the picture is set to the target block group, and motion detection is consecutively performed in order from the upper-right block to the lower-left block,
and wherein, in the advancing motion detection, motion detection is advanced from the left block group to the right block group along the horizontal direction.
